(19) United States
(12) Patent Application Publication
(10) Pub. No.: US 2012/0021249 A1
(43) Pub. Date: Jan. 26, 2012

(54) METHOD OF CONTROLLING NUMBER OF GRAPHENE LAYERS

(75) Inventors: Hyeon-jin SHIN, Suwon-si (KR); Jae-Young CHOI, Suwon-si (KR); Gang-hee HAN, Bucheon-si (KR); Young-hee LEE, Suwon-si (KR)

(73) Assignee: SAMSUNG ELECTRONICS CO., LTD., Suwon-si (KR)

(21) Appl. No.: 13/167,933

(22) Filed: Jun. 24, 2011

(30) Foreign Application Priority Data
Jun. 25, 2010 (KR) 10-2010-0060659

(51) Int. Cl. B32B 9/00; B05D 5/00; B05D 3/06; B82Y 30/00; B82Y 40/00

(52) U.S. Cl. 428/688; 427/553; 427/554; 977/842; 977/734

(57) ABSTRACT

A method of controlling the number of layers of graphene layers includes forming graphene on a first surface of a first substrate, and forming a second substrate on a second surface of the first substrate; and irradiating the graphene with light to cause constructive Fresnel interference, wherein a multilayer structure or non-uniform graphene structure formed on the a surface of the graphene is removed by the constructive Fresnel interference.

### CROSS-REFERENCE TO RELATED APPLICATIONS

This application claims priority to Korean Patent Application No. 10-2010-0060659, filed on Jun. 25, 2010, and all the benefits accruing therefrom under 35 U.S.C. 119, the content of which in its entirety is herein incorporated by reference.

### BACKGROUND

1. Field

The present disclosure relates to methods of controlling the number of graphene layers, and more particularly, to methods of controlling the number of graphene layers in which uniformity and desired layers of graphene are obtained by removing multilayer particles of the graphene.

2. Description of the Related Art

Graphite is an allotropic form of the element carbon having a layered structure in which two-dimensional (“2D”) single sheets formed of sp²-hybridized, hexagonal rings of carbon, connected together to form an extended pi-electron system, are stacked. A single such sheet is referred to as graphene. There are two further and specific allotropic forms of graphite having different stacking arrangements, hexagonal and rhombohedral. Removal of one or more graphene sheets from graphite provides a material having useful electrical, mechanical, and other characteristics for the single graphene sheet, when compared with existing electrically conductive and other materials.

The electrical characteristics of a graphene sheet depend upon the crystallographic orientation of the graphene sheet, which allows for selection of electrical characteristics suitable for the design of a device. Accordingly, a graphene sheet may be effectively used in a carbon-based electrical device or a carbon-based electromagnetic device.

Uniform graphene sheets, however, may not be readily formed, and depending upon the process for preparing the graphene sheet, may have defects. For example, multilayered particles in which the number of graphene layers is not uniform, can form on the graphene sheet, affecting the overall uniformity of the graphene sheet.

### SUMMARY

Provided are methods of improving uniformity of graphene by reducing the number of layers of the graphene by using a simple process.

Additional embodiments will be set forth in part in the description which follows and, in part, will be apparent from the description, or may be learned by practice of the presented embodiments.

According to an embodiment, a method for controlling a number of graphene layers includes forming graphene on a first surface of a first substrate, and forming a second substrate on a second surface of the first substrate; and irradiating the graphene layer with light to cause constructive Fresnel interference, wherein a multilayer structure or non-uniform structure on a surface of the graphene is removed by the constructive Fresnel interference.

The light may be a laser beam.

A refractive index of the first substrate may be smaller than a refractive index of the second substrate, and a wavelength of the light may satisfy Equation 2 below:

2m×0.5λ=2nL, Equation 2

where λ is a wavelength of light, n is a refractive index of the first substrate, L is a thickness of the first substrate, and m is a positive integer. It will be appreciated that refractive index varies with wavelength, and thus where refractive indices are specified for a system, the refractive index values used are determined at the same wavelength, such as for example at a wavelength of 589 nm corresponding to the sodium-D line, or are determined for the wavelength used for irradiation.

The number of layers of the graphene from which the multilayer or non-uniform graphene is removed may be one or two.

A refractive index of the first substrate may be more than about 1 and less than about 2.5.

The first substrate may be an organic substrate, or a metal oxide substrate.

The first substrate may include at least one metal oxide selected from the group consisting of SiO₂, Al₂O₃, ZrO₂, HfO₃, Fe₂O₃, MgO, and any combination thereof.

The second substrate may include at least one inorganic substrate selected from the group consisting of a silicon substrate, a glass substrate, a GaN substrate, a silica substrate, and any combination thereof; and at least one metal substrate selected from the group consisting of nickel (Ni), cobalt (Co), iron (Fe), platinum (Pt), palladium (Pd), gold (Au), aluminum (Al), chromium (Cr), copper (Cu), manganese (Mn), molybdenum (Mo), rhodium (Rh), iridium (Ir), tantalum (Ta), titanium (Ti), tungsten (W), uranium (U), vanadium (V), zirconium (Zr), an alloy thereof, and any combination thereof.

The graphene formed on the first surface of the first substrate may have an area of 1 cm² or more.

The graphene formed on the first surface of the first substrate may have 10 or less wrinkles per an area of 1000 μm².

The graphene formed on the first surface of the first substrate may be present in an area of 99% or greater per 1 mm² of the graphene.

According to another embodiment, a monolayer graphene is prepared by according the method.

According to another embodiment, a bilayer graphene is prepared by using the method.

The monolayer graphene or the bilayer graphene may be used in various electrical devices such as transparent electrodes, memory devices, transistors, and sensors.

### BRIEF DESCRIPTION OF THE DRAWINGS

These and/or other features will become apparent and more readily appreciated from the following description of the embodiments, taken in conjunction with the accompanying drawings of which:

FIG. 1 shows irradiation of graphene on a bilayer substrate using laser light, according to an embodiment;

FIG. 2A shows irradiation of graphene on a bilayer substrate using laser light in which constructive interference occurs;

FIG. 2B shows irradiation of graphene on a first and second substrate in which destructive interference occurs;

FIG. 3 shows an optical image of a resulting product after the laser etching of Example 1 is performed;

FIG. 4A shows graphene before irradiation with light; and

FIG. 4B shows an atomic force microscopy (“AFM”) image of graphene after irradiation with light.

### DETAILED DESCRIPTION

According to an embodiment, a method of controlling the number of graphene layers, such as on a surface of a substrate, is provided. The method includes forming graphene on a first surface of a first substrate, and forming a second substrate on a second surface of the first substrate; and irradiating the graphene with light to cause Fresnel interference (i.e., constructive interference). In this case, multilayer graphene structures and non-uniform graphene which may be present in different regions of the graphene are removed from the graphene by the Fresnel interference.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, regions, integers, steps, operations, elements, and/or components, but do not preclude the presence or addition of one or more other features, regions, integers, steps, operations, elements, components, and/or groups thereof. All ranges and endpoints reciting the same feature are independently combinable.

It will be understood that when an element is referred to as being “on” another element, it can be directly on the other element or one or more intervening elements may be present. Also as used herein, the term “disposed on” describes the fixed structural position of an element with respect to another element, and unless otherwise specified should not be construed as constituting the action of disposing or placing as in a method step. As used herein, the term “and/or” includes any and all combinations of one or more of the associated listed items.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower”, can therefore, encompasses both an orientation of “lower” and “upper,” depending on the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

It will be understood that, although the terms first, second, third, etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the present invention.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

According to the method, monolayer or bilayered graphene may be prepared by the use of light to irradiate the graphene by a simple process, which overcome uniformity issues (i.e., non-uniform graphene surfaces) obtained by general monolayer and bilayered growth technologies, or ozone etching.

The term “graphene” as used herein refers to a fused polycyclic aromatic molecule comprising a plurality of sp² hybridized carbon atoms interconnected to each other by covalent bonds. The plurality of carbon atoms may form a six-membered ring as a standard repeating unit, or may further include 5-membered rings and/or 7-membered rings in addition to 6-membered rings. The graphene and general graphite may be distinguished according to the number of layers included in the graphene or the general graphite. Generally, graphene includes 300 individual layers or less, and may be one or two layers in a specific embodiment.

The graphene prepared by using a method of controlling the number of graphene layers according to an embodiment may have a uniform monolayer or bilayer structure in which field-effect transistors (“FETs”) or band gaps are readily formed. The number of layers included in the graphene may be determined according to various factors such as the kind of substrate used, or the intensity of the light used for irradiation.

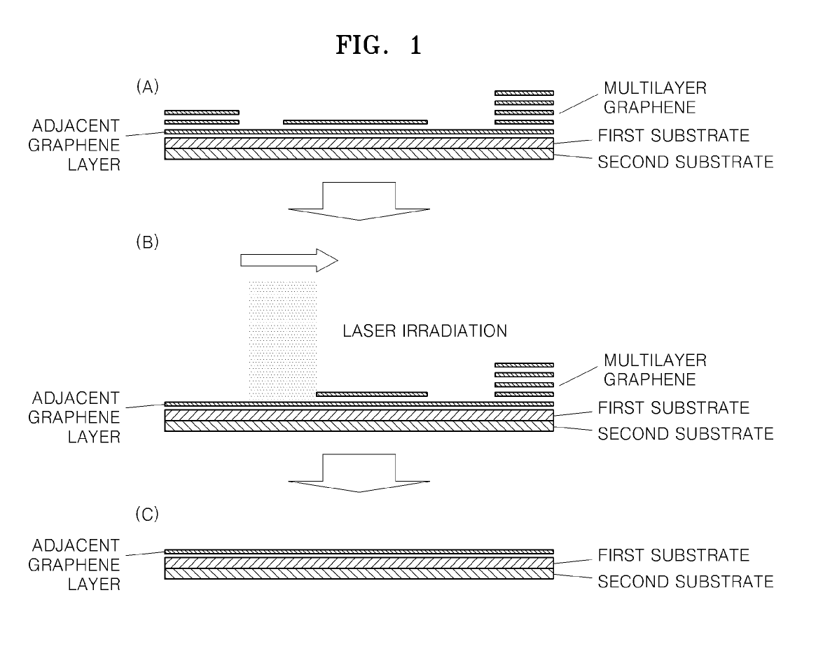

According to an embodiment, as illustrated in FIG. 1, the number of layers in the graphene may be controlled by forming the graphene (i.e., adjacent and multilayer graphene) on a first substrate including second substrates that are formed on upper and/or lower surfaces of the first substrate (FIG. 1A) and then irradiating the graphene with light (FIG. 1B), to effect combustion and removal of multilayer or non-uniform graphene structures according to light interference, and heat accumulation (FIG. 10). “Light” as used herein may be broadband radiation in the ultraviolet (<400 nm), visible (400-750 nm) or infrared (>750 nm) wavelengths. Preferably, light used to irradiate the graphene is coherent light, i.e., laser light. Laser light may be of a visible wavelength of e.g., 633, 532 nm, or the like. Irradiation may be carried out by scanning laser irradiation across the graphene surface (direction of arrow, illustrated as left-to-right in FIG. 1B).

When the graphene formed on the first substrate is irradiated with light, light passes through the graphene, and a portion of the light is absorbed by the graphene, heating it. The graphene is oxidized by ambient oxygen and the absorbed heat, and undergoes combustion. That is, optical energy is transferred directly to an exposed portion of the graphene formed on the first substrate to generate a large amount of absorbed heat, and the portion so exposed is readily combusted. However, a different portion of the graphene, specifically the portion adjacent to and in contact with the first substrate, is prevented from undergoing combustion since the first and second substrates act as heat sinks and absorb heat from the contacting graphene transferring it to the first and second substrates. In this way, the portion of the graphene adjacent to the first substrate selectively does not undergo combustion, but regions of multilayer graphene on the graphene adjacent to the first substrate do undergo combustion, and hence the number of layers in the graphene may be controlled.

In order to readily combust the graphene, the optical energy of the light used for irradiation must be effectively transferred to the graphene. That is, when the graphene is irradiated with light, the surface area of the graphene which can be directly irradiated with light in order to produce heat in the graphene is not great, and a significant amount of light passes through the graphene due to the optical characteristics of graphene. Thus, the heat generated in the graphene by simple optical irradiation is insufficient to combust the graphene. However, energy may be effectively transferred to the graphene layer by amplification of the optical energy due to Fresnel interference.

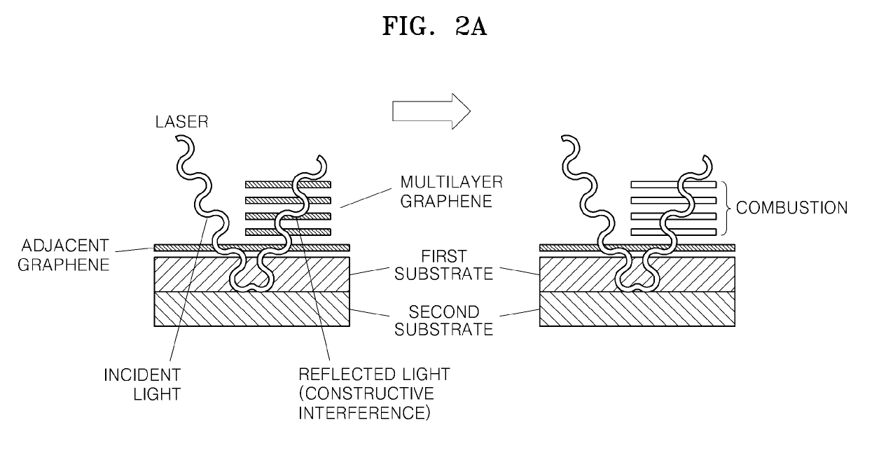

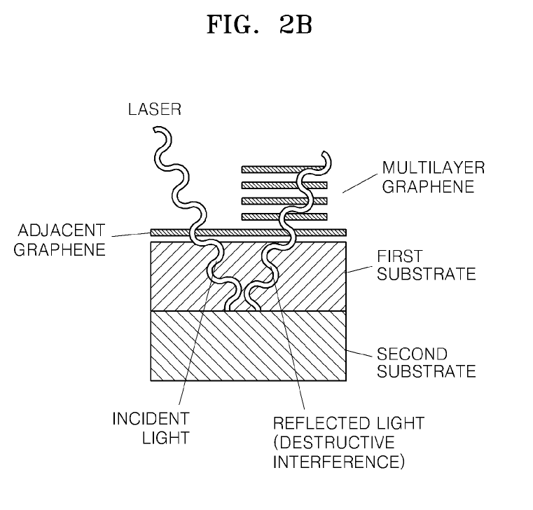

The optical energy transferred to the graphene by irradiating light may be explained by a combination of optical energy that is transmitted and absorbed by direct irradiation, and optical energy that passes through a substrate, and then is reflected and absorbed. As illustrated in FIG. 2A, when constructive Fresnel interference occurs between the optical energy (incident light) that passes through the substrate and then is reflected, and the optical energy that is reflected off a surface of the substrate, the constructive interference optical energy is amplified to transfer a larger amount of energy to the multilayer graphene than would be obtained from irradiation of the multilayer graphene with incident radiation alone (where the combination of the reflected light from the first surface and that reflected from the interface between the first and second substrates is the reflected light with constructive interference), and thereby the graphene may effectively undergo combustion. In contrast, in FIG. 2B, destructive interference occurs in the reflected light, reducing the amount of light that may be absorbed by the multilayer graphene, and thus effective combustion of the multilayer graphene may not occur.

Constructive interference or destructive Fresnel interference may be achieved based on several different parameters, including but not limited to wavelength of the light used in the irradiation, intensity of the light, composition (and hence refractive indices) of the first and second substrates, and the relative thicknesses of the graphene (including multilayer graphene) and the first and second substrates.

According to an embodiment, when the refractive index of the first substrate is smaller than that of the second substrate, the wavelength of the light useful for irradiation satisfies Equation 1 below:

2m×0.5λ=2nL Equation 1

In Equation 1, λ is a wavelength of light, n is the refractive index of a substrate, L is the thickness of the substrate, and m is a positive integer.

For example, where a silica (SiO₂) substrate is used as the first substrate, and a silicon (Si) substrate is used as the second substrate, incident light passes through the graphene formed on the first substrate and a portion of this incident light is absorbed by the graphene. The unabsorbed portion of the incident light then passes through the first substrate without any further or significant loss in intensity, and the light reflects off the interface between the first substrate and the second substrate. The light reflected off the interface between the first substrate and the second substrate then passes through the first substrate, and at least a portion of this reflected light is absorbed by the graphene. The light reflected off the interface between the graphene and the first substrate, is then absorbed by the graphene, and the reflected light so absorbed by the graphene is converted into thermal energy, according to Fresnel interference. Thus, the graphene formed on the first substrate evaporates in the form of carbon oxides (COₓ).

Fresnel interference occurring in the SiO₂ substrate that is the first substrate, and on the silicon substrate that is the second substrate, may be defined as follows.

When a laser emitting light at a wavelength of, for example, 532 nm is used as incident light, refractive indexes (n_{SiO2}, n_{Graphene}, and n_{Si}) of SiO₂, graphene, and silicon are given by the following equations.

n_{SiO2}≡nₒₓ=1.47

n_{Graphene}≡n_{G}=2.0−1.1i, or 2.3−1.6i

n_{Si}=5.6−0.4i

A refraction coefficient (r_{Air/Graphene}) between air and graphene, a refraction coefficient (r_{Graphene/SiO2}) between graphene and a SiO₂ substrate, and a refraction coefficient (r_{SiO2/Si}) between the SiO₂ substrate and a silicon substrate are defined by the following equations.

r_{Air/Graphene}≡r_{A/G}=(n_{Air}−n_{G})/(n_{Air}+n_{G})

r_{Graphene/SiO2}≡r_{G/ox}=(n_{G}−n_{SiO2})/(n_{G}+n_{SiO2})

r_{SiO2/Si}≡r_{ox/Si}=(n_{SiO2}−n_{Si})/(n_{SiO2}+n_{Si})

In this case, path differences (φ_{Graphene} and φ_{SiO2}) are defined as follows.

φ_{Graphene}≡φ_{G}=2πd_{G}n_{G}/λ

φ_{SiO2}≡φₒₓ=2πdₒₓnₒₓ/λ

In these equations, ‘d’ is the thickness of each substrate (d_{G} and dₒₓ), and λ is the wavelength of incident light.

As a result, reflectance (R_{G/sub}) is defined as follows.

$$\begin{matrix}{R}_{G / sub} = {\vert {r}_{g / sub}^{†} {r}_{G / sub} \vert}^{2} \\ = {\vert \begin{matrix}( \begin{matrix}{r}_{A / G} {e}^{i ( ϕ G + ϕ ox )} + \\ {r}_{G / ox} {e}^{- i ( ϕ G - ϕ ox )} + \\ {r}_{ox / Si} {e}^{- i ( ϕ G + ϕ ox )} + \\ {r}_{A / G} {r}_{G / ox} {r}_{ox / Si} {e}^{i ( ϕ G - ϕ ox )}\end{matrix} ) / \\ ( \begin{matrix}{e}^{i ( ϕ G + ϕ ox )} + \\ {r}_{A / G} {r}_{G / ox} {e}^{- i ( ϕ G - ϕ ox )} + \\ {r}_{A / G} {r}_{ox / Si} {e}^{- i ( ϕ G + ϕ ox )} + \\ {r}_{G / ox} {r}_{ox / Si} {e}^{i ( ϕ G - ϕ ox )}\end{matrix} )\end{matrix} \vert}^{2}\end{matrix}$$

However, for graphene, when n_{G} is replaced with n_{Air}, reflectance (R_{sub}) of each substrate is defined as follows.

R_{sub}=|r_{sub}^{†}r_{sub}|²=|(r_{A/ox}e^{i(φox)}+r_{ox/Si}e^{-i(φox)})/(e^{i(φox)}+r_{A/ox}r_{ox/Si}e^{i(φG-φox)})|²

Final reflectance of graphene is defined as follows.

A_{G}=R_{sub}−R_{G/sub}

According to the above Fresnel equations and the thermodynamics of combustion of graphene, when about 2% or more of total incident light (i.e., incident light plus reflected light) is absorbed by the graphene, the graphene may undergo combustion. In this case, the amount of combusted graphene may be determined according to factors such as the intensity of incident light, and the refractive index (the thickness) of the first substrate.

Choice of substrate composition determines and fixes the refractive index (n) in the above equations. In addition, use of a substrate with a predetermined thickness fixes the thickness (L) in the above equations. Thus, where the substrate composition and thickness are fixed, the remaining factor for determining Fresnel interference is primarily the wavelength (λ) of light used for irradiation. That is, when the kind and thickness of the substrate are determined, constructive Fresnel interference may obtained in the irradiated substrates by appropriately adjusting the wavelength of light. Alternatively, in another method, when the wavelength of light and the kind of substrate are determined, constructive Fresnel interference may be obtained by adjusting the thickness(es) of the substrate(s). In still another method, when the wavelength of light is fixed by choice of illumination method, constructive Fresnel interference may be obtained by adjusting the composition of the substrate, i.e., the refractive index.

Any material suitable for preparing the first substrate may be used, so long as the material can provide a structural surface, and the refractive index of the first substrate prepared from the material may be greater than about 1.0 to less than about 2.5, for example, about 1.2 to about 1.8. A material for preparing a substrate that has a refractive index meeting these limitations provides sufficient reflectance while preventing the substrate from being damaged.

The first substrate may be, for example, an oxide substrate, or an organic substrate. Organic substrates having high thermal conductivity and high heat resistance including thermosets and thermoplastics may be used, such as one selected from the group consisting of polyimide, polyetherimide, polyphenylene oxide, polycarbonate, epoxy, polyorganosiloxanes, and a combination thereof. The oxide substrate may be a metal oxide substrate that may be at least one selected from SiO₂, Al₂O₃, TiO₂, ZrO₂, HfO₃, Fe₂O₃, MgO, and any combination thereof. Oxide substrates are preferred for their high thermal stability and thermal conductivity.

Light incident on the graphene may be from a coherent light source, such as a laser beam. The intensity of the laser beam produced by the light source may be from about 10 to about 500 mW.

As described above, by causing a constructive Fresnel interference on graphene, an amount of light absorbed by the graphene may be increased, and thus at least a portion of the surface of the graphene (i.e., the multilayer graphene; see e.g., FIG. 1) may be oxidized and combusted. A small amount of heat is absorbed by the remaining portion of the graphene, which is adjacent to the substrate. Thus, monolayer graphene or bilayered graphene may remain. By appropriately adjusting the optical energy or the thickness of the substrate, three-layered or four-layered graphene may be formed.

By using the method of controlling the number of graphene layers, the number of layers of multilayer graphene may be controlled, and non-uniform portions included in the graphene, such as grains may be removed. That is, the grains constitute a region where a multilayer graphene is formed. Heat that is produced in the graphene by irradiating light is concentrated in the grains, and thus the grains may be oxidized and combusted. Accordingly, the monolayer or bilayered graphene is obtained by removing the non-uniform region such as the grains, and the monolayer or bilayered graphene thereby exhibits improved uniformity.

The second substrate on the surface of the first substrate opposite the graphene may be at least one selected from the group consisting of an inorganic substrate such as a silicon (Si) substrate, a glass substrate, a GaN substrate, and a silica substrate; and a metal substrate of nickel (Ni), cobalt (Co), iron (Fe), platinum (Pt), palladium (Pd), gold (Au), silver (Ag), aluminum (Al), chromium (Cr), copper (Cu), manganese (Mn), molybdenum (Mo), rhodium (Rh), iridium (Ir), tantalum (Ta), titanium (Ti), tungsten (W), uranium (U), vanadium (V), and zirconium (Zr); and any combination thereof. In addition, the first substrate may be an oxide substrate that is at least one selected from the group consisting of SiO₂, Al₂O₃, TiO₂, ZrO₂, HfO₃, Fe₂O₃, MgO, and any combination thereof. The thicknesses of the first and second substrate are not be particularly limited, so long as the thicknesses of the first and second substrates are selected according to uses and processes compatible with the principles of operation of the method.

Graphene having a controlled number of layers and improved uniformity may have semiconductor characteristics by controlling the number of layers to adjust band gaps according to uses. Thus, the graphene obtained according to the above method may be useful in various display devices, such as a field emission display (“FED”), a liquid crystal display (“LCD”), or an organic light emitting device (“OLED”); various electrical devices, such as a super-capacitor, a fuel cell, or a solar cell; or various nano-devices, such as a field-effect transistor (“FET”), or a memory device; a transparent electrode; a hydrogen storage device; an optical fiber; a sensor; or another electrical device. The graphene may be used in any combination of applications comprising at least one of the foregoing.

Graphene used in the method is not particularly limited, but may have few or no defects if possible. The graphene sheet may have 10 or less wrinkles, about 5 or less, or 3 or less wrinkles, per 1,000 μm² area of the graphene sheet. The graphene may have an area of 1 mm² or greater, an area of about 1 mm² to about 100 m², or an area of about 1 mm² to about 25 m². Graphene may be present in an area of 99% or greater, or in an area of about 99% to about 99.999%, per 1 mm² of the graphene. Where graphene is present in this area range, the graphene may be homogeneous, and thus may have uniform electrical characteristics.

The graphene used in the method may be prepared by using the following preparation methods, but embodiments of the present invention are not limited thereto. The graphene may be prepared by transcribing graphene prepared by using a separate method, or by growing graphene directly on a substrate.

### Graphene Formation Process (Vapor-Phase Method)

Graphene may be formed on a metallic graphitization catalyst layer by a known method, such as for example, a vapor-phase method or a liquid-phase method.

For example, a vapor-phase method will now be described briefly. First, a graphitization catalyst is formed by deposition as a film, and then graphene is formed on a surface of the graphitization catalyst by heat-treating while loading a vapor-phase carbon supply source thereon, thereby forming graphene. Then, the formed graphene (i.e., the graphene formed prior to light exposure by constructive Fresnel interference) is grown from the adsorbed carbon supply source under cool (e.g., less than about 500° C.) conditions. That is, a vapor-phase carbon supply source is loaded at a given pressure into a chamber in which a graphitization catalyst is present in a form of a film and then, heat-treated at a given temperature for a given time period, thereby forming graphene in which carbon elements present in the vapor carbon supply source bond to each other to form a hexagonal planar structure. Then, the graphene is cooled at a given cooling rate to form a graphene sheet having a uniform arrangement structure on the metallic graphitization catalyst layer.

In the graphene sheet formation process described above, the carbon supply source may be any of various graphene precursor materials that supply carbon and are present in a vapor phase at a temperature of 300° C. or more. The vapor carbonaceous material may be any carbon-containing compound. For example, the vapor carbonaceous material may be a compound including six or less carbon atoms, a compound including four or less carbon atoms, or a compound including two or less carbon atoms. For example, the vapor carbonaceous material may include, but is not limited to, at least one selected from the group consisting of carbon monoxide, ethane, ethylene, ethanol, acetylene, propane, propylene, butane, butadiene, pentane, pentene, isoprene, cyclopentadiene, hexane, cyclohexane, benzene, toluene, and any combination thereof.

The vapor carbonaceous material may be injected into a chamber containing a graphitization catalyst at a desired pressure. The vapor carbonaceous material may be used alone or in a combination with an inert gas, such as, for example, helium or argon.

Alternatively, hydrogen may be further included together with the vapor carbonaceous material. Inclusion of hydrogen maintains a clean surface of the metal layer containing the catalyst, and thus may control the reaction of the vapor carbonaceous material with the metal layer. Hydrogen may be used at about 5 to about 40% by volume of the chamber in which the graphene is formed, about 10 to about 30% by volume, or about 15 to about 25% by volume, at a given pressure.

When the vapor carbon supply source is loaded into the chamber in which the graphitization catalyst is present in a film form and is then heat-treated at a given temperature, graphene forms on a surface of the metallic graphitization catalyst layer. The heat treatment temperature may play a critical role in forming graphene, and may be, for example, from about 300 to about 2,000° C., or from about 500 to about 1,500° C.

An amount of formed graphene may be controlled by performing the heat treatment at a give temperature for a given time period. That is, when the heat treatment process is performed for a relatively long time period, more graphene is formed. Thus, in this instance, the thickness of formed graphene may be large, whereas, when the heat treatment process is performed for a relatively short time period, the thickness of the formed graphene is small. Accordingly, in manufacturing monolayer graphene having a target thickness, the heat treatment time may also play a critical role, in addition to the type and supply pressure of the carbon supply source, the size of the graphitization catalyst, and the size of the chamber. The heat treatment time may vary greatly and may be, for example, about 0.001 to about 1,000 hours.

A heat source for the thermal treatment is not limited, and may be induction heat, radiant heat, a laser, infrared (“IR”) heat, microwaves, plasma, ultraviolet (“UV”) rays, or surface plasmon heat. The heat source is attached to the chamber, and increases a temperature inside the chamber up to a predetermined temperature.

A selected cooling process is performed on the resulting product obtained after the thermal treatment. The cooling process is performed so that the patterned graphene is grown and arranged uniformly. Since sudden cooling may generate cracks in the graphene sheet, the resulting product may be slowly cooled at a uniform rate. For example, the resulting product may be cooled at a controlled rate of from about 0.1° C. to about 10° C. per minute, or may be cooled naturally (e.g., by ambient convection). The cooling of the resulting product naturally is performed by simply removing the heat source used for the thermal treatment. Thus, by removing only the heat source, a sufficient cooling rate may be obtained.

The heat treatment and the cooling process described above may be performed once. However, the cycle of heating and cooling may be repeatedly performed to generate graphene having a dense structure and a large number of layers.

The graphitization catalyst is used in the form of a film having a planar structure, and contacts the carbon supply source so as to facilitate the formation of a hexagonal planar structure of carbon elements provided from the carbon supply source. The graphitization catalyst may be a catalyst used in graphite synthesis, carbonation induction, or carbon nanotube production. For example, the catalyst may comprise at least one metal selected from the group consisting of Ni, Co, Fe, Pt, Au, Al, Cr, Cu, Mg, Mn, Mo, Rh, Si, Ta, Ti, W, U, V, Zr, alloys thereof, and any combination thereof.

A graphene manufactured by the vapor-phase method described above may have a uniform structure without defects since pure vapor materials and a high-temperature heat treatment are used.

### Graphene Formation Process (Polymerization)

The monolayer graphene may also be formed by polymerization. The polymerization process is for allowing the metallic graphitization catalyst layer and a liquid carbon supply source to contact each other. For example, a carbon-containing polymer may be used as a carbon supply source and may be coated on the metallic graphitization catalyst layer described above.

Any carbon-containing polymer may be used as the carbonaceous material. When a self-assembled polymer is used, the self-assembled polymer may be vertically arranged (orthogonal to the plane of the surface of e.g., the metallic graphitization catalyst layer) in a regular pattern, and thus the resulting graphene may have a high density.

The self-assembled polymer, which forms a self-assembled layer, may be at least one self-assembled polymer selected from the group consisting of an amphiphilic polymer, a liquid crystal polymer, a conductive polymer, or a combination comprising at least one of the foregoing.

Since the amphiphilic polymer has both hydrophilic and hydrophobic functional groups in a structure thereof, the amphiphilic polymer may be arranged in a uniform arrangement, such as a Langmuir-Blodgett arrangement, a dipping arrangement, or a spin arrangement, in an aqueous solution. The amphiphilic polymer includes a hydrophilic functional group including at least one selected from the group consisting of an amino group, a hydroxyl group, a carboxyl group, a sulfate group, a sulfonate group, a phosphate group, a salt thereof, and a combination comprising at least one of the foregoing; and a hydrophobic functional group including at least one selected from the group consisting of a halogen atom, a C1-30 alkyl group, a C1-30 halogenated alkyl group, a C₂-C₃₀ alkenyl group, a C₂-C₃₀ halogenated alkenyl group, a C₂-C₃₀ alkynyl group, a C₂-C₃₀ halogenated alkynyl group, a C₁-C₃₀ alkoxy group, a C₁-C₃₀ halogenated alkoxy group, a C₁-C₃₀ heteroalkyl group, a C₁-C₃₀ halogenated heteroalkyl group, a C₆-C₃₀ aryl group, a C₆-C₃₀ halogenated aryl group, a C₇-C₃₀ arylalkyl group, a C₇-C₃₀ halogenated arylalkyl group, and a combination comprising at least one of the foregoing. Examples of the amphiphilic polymer include a decanoic acid, a lauric acid, a palmitic acid, a stearic acid, a myristoleic acid, a palmitoleic acid, an oleic acid, a stearidonic acid, a linolenic acid, a caprylamine, a laurylamine, a stearylamine, an oleylamine, or a combination comprising at least one of the foregoing.

The liquid crystal polymer is arranged in a uniform orientation in liquid. The conductive polymer forms a specific crystalline structure by self-assembling in a layer of the polymer while a solvent used to dissolve the conductive polymer vaporizes from the layer. Accordingly, the liquid crystal polymer and the conductive polymer may be arranged on a surface by a method, such as dipping, spin coating, or the like. Examples of the liquid crystal polymer and the conductive polymer include a polyacetylene-based polymer, a polypyrrole-based polymer, a polythiophene-based polymer, a polyaniline-based polymer, a polyfluorinated polymer, a poly(3-hexylthiophene)-based polymer, a polynaphthalene-based polymer, a poly(p-phenylene sulfide)-based polymer, a poly(p-phenylene vinylene)-based polymer, or a combination comprising at least one of the foregoing.

The carbon-containing polymer may include at least one polymerizable functional group, such as a carbon-carbon double bond or a carbon-carbon triple bond, in a structure thereof. The at least one polymerizable functional group may enable polymerization between polymers (e.g., cross-linking) through a polymerization process, such as ultraviolet light irradiation, after forming a layer thereof. The carbonaceous material obtained therefrom may have a large molecular weight, and thus may substantially reduce or effectively prevent carbon from being volatized during thermal treatment.

Such a carbon-containing polymer may be polymerized before or after being coated on the graphitization catalyst. In an embodiment, when the carbon-containing polymer is polymerized before being coated on the graphitization catalyst, a polymerization layer obtained through a separate polymerization process may be transferred on the graphitization catalyst to obtain the carbonaceous material. Such a polymerization process and a transferring process may be repeated several times to adjust the thickness of the patterned graphene.

The carbon-containing polymer may be arranged on the graphitization catalyst by any suitable method. For example, the carbon-containing polymer may be arranged on a surface of the graphitization catalyst by using a Langmuir-Blodgett method, a dip coating method, a spin coating method, or a vacuum-deposition method. Through such coating methods, the carbon-containing polymer may be coated on a portion of or an entire surface of the substrate or the graphitization catalyst.

In an embodiment, the molecular weight of the carbon-containing polymer, the thickness of a layer, or the number of self-assembled layers of the carbon-containing polymer arranged on the substrate, may be selected according to the desired number of layers of the patterned graphene. In an embodiment, when the carbon-containing polymer having a large molecular weight is used, the amount of carbon is high, and thus the number of layers of the patterned graphene is also high. The thickness of the patterned graphene may be selected according to the molecular weight of the carbon-containing polymer.

An amphiphilic organic material may be a self-assembled organic material and include both a hydrophilic portion and a hydrophobic portion in its molecular structure. The hydrophobic portion of the amphiphilic organic material, such as for example, an amphiphilic polymer, binds to the graphitization catalyst layer, which is hydrophobic, thus being evenly arranged on the graphitization catalyst layer. As a result, the hydrophilic portion of the amphiphilic organic material is oriented in a direction away from the substrate, and thus binds to a hydrophilic portion of the amphiphilic organic material, such as an amphiphilic polymer, which is not bonded to the graphitization catalyst layer. When the amount of the amphiphilic organic material is sufficient, the amphiphilic organic material may be sequentially stacked on the graphitization catalyst layer by alternating interfaces of hydrophilic-hydrophilic and hydrophobic-hydrophobic bonds. After the amphiphilic organic material forms a plurality of such layers, a graphene layer is formed by thermal treatment. Accordingly, by selecting a suitable amphiphilic organic material, and selecting a thickness of layers of the amphiphilic organic material by varying the amount of the amphiphilic organic material, the number of layers of graphene may be selected. Thus, graphene having a desired thickness may be prepared.

### Graphene Formation Process (Liquid-Phase Method)

The monolayer graphene may also be formed by using a liquid-phase method. In the liquid-phase method, the metallic graphitization catalyst layer contacts a liquid carbon supply material and then the resultant is heat-treated to form graphene.

In the contacting of the metallic graphitization catalyst layer and the liquid carbon supply material, the metallic graphitization catalyst layer is immersed in the liquid carbon supply material used as a carbonaceous graphene precursor material, and then the liquid carbon supply material so contacted to the metallic graphitization catalyst layer is pre-heated.

A liquid carbonaceous material used in the liquid phase carburization method may be any organic solvent containing carbon and may be thermally decomposed by a reaction with the graphitization catalyst. The hydrocarbon material may be a polar organic solvent or non-polar organic solvent having a boiling point of about 60 to about 400° C. Examples of such organic solvents may include alcohol-based organic solvents, ether-based organic solvents, ketone-based organic solvents, ester-based organic solvent, and organic acid-based organic solvents. An alcohol-based organic solvent or an ether-based organic solvent may be selected for use for its adsorption to the metallic graphitization catalyst, its reactivity and its reducing potential. Examples of alcohol-based organic solvents include monovalent alcohols and polyvalent alcohols, which may be used alone or in a combination thereof. Examples of monovalent alcohols useful as liquid phase carbon supply materials include propanol, pentanol, hexanol, heptanol, and octanol, and examples of polyvalent alcohols include propylene glycol, diethylene glycol, dipropylene glycol, triethylene glycol, tripropylene glycol, octylene glycol, tetraethylene glycol, neopentyl glycol, 1,2-butandiol, 1,3-butandiol, 1,4-butandiol, 2,3-butandiol, 1,2-dimethyl-2,2-butandiol, and 1,3-dimethyl-2,2-butandiol. Combinations comprising at least one of the foregoing may also be used. These monovalent alcohols and polyvalent alcohols may further include additional functional groups, such as an ether group, in addition to a hydroxyl group.

When such a liquid carbonaceous material is used, the metallic graphitizing catalyst layer may be carburized by the pre-heating. The liquid carbonaceous material may be thermally decomposed during the pre-heating due to a reaction with the graphitization catalyst. A thermal decomposition process of a liquid hydrocarbon material by a graphitizing catalyst is well known (Nature, 2002, Vol. 418, p. 964-967). For example, thermal decomposition products of an organic solvent such as polyvalent alcohol may include alkanes, H₂, CO₂, and H₂O, and a carbon component of the thermal decomposition products permeates into a catalyst. The article identified above is incorporated in its entirety into the specification by reference.

The pre-heat treatment for the thermal decomposition may be performed for from about 10 minutes to about 24 hours.

In addition, when a carburization method is used, the amount of carbon in the catalyst may be controlled by varying the degree of carburization. Thus, the thickness of a graphene layer formed in a subsequent process may also be controlled. For example, if a liquid carbonaceous material that is prone to thermal decomposition is used, a large amount of carbon may be decomposed and permeated into the catalyst layer during the thermal decomposition reaction of the liquid carbonaceous material. In addition, the amount of carbon permeated into the catalyst layer may also be controlled by varying the preheating temperature and duration. The rate of growth of graphene may thus be controlled, and therefore, the number of layers of the graphene may be controlled.

As described above, a carbon-containing polymer or a liquid carbon supply source is brought into contact with the metallic graphitization catalyst layer, and then a heat treatment is performed thereon, forming graphene on the metallic graphitization catalyst layer. The heat treatment may then be performed in the same manner as in the vapor-phase method.

The disclosed embodiments will be described in further detail with reference to the following examples. The following examples are for illustrative purposes only and are not intended to limit the scope of the invention.

### EXAMPLE 1

A silica (SiO₂) layer (refractive index: 1.47 at 589 nm) having a size of 1 cm×1 cm, and a thickness of 300 nm was prepared on a silicon substrate having a size of 1 cm×1 cm, and a thickness of 525 μm, and then four-layered graphene having a size of 10 μm×10 μm was transcribed on the SiO₂ wafer. Then, the graphene was scanned using light having a wavelength of 532 nm and an intensity of 80 mW was with a laser device (WiTec CRM 200 Confocal Raman Microscope, 100× lens, N.A. 0.9).

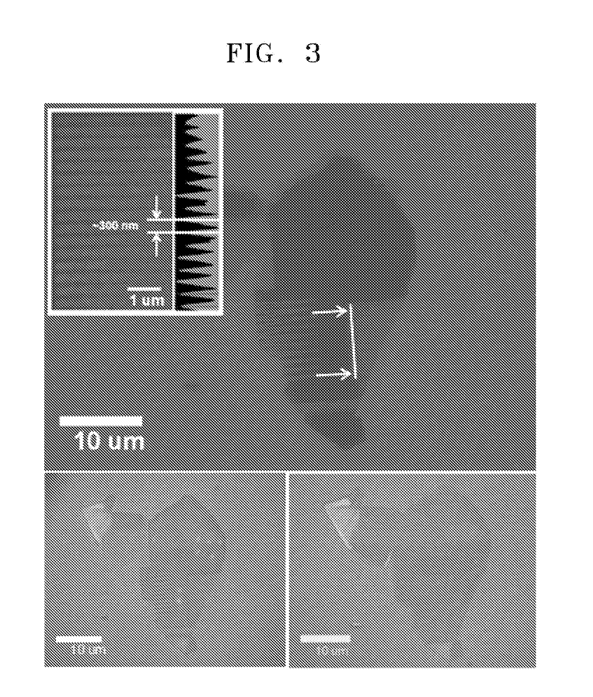

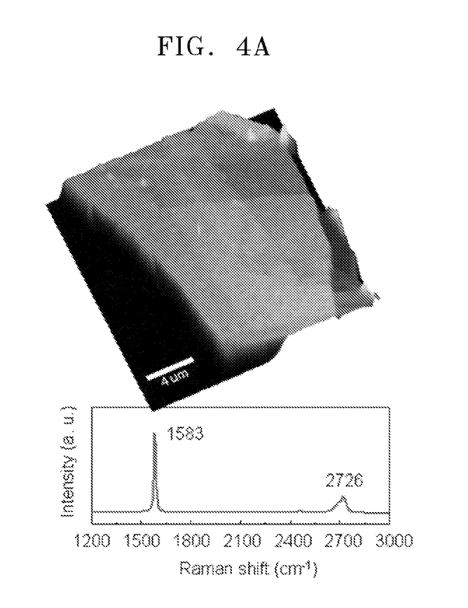

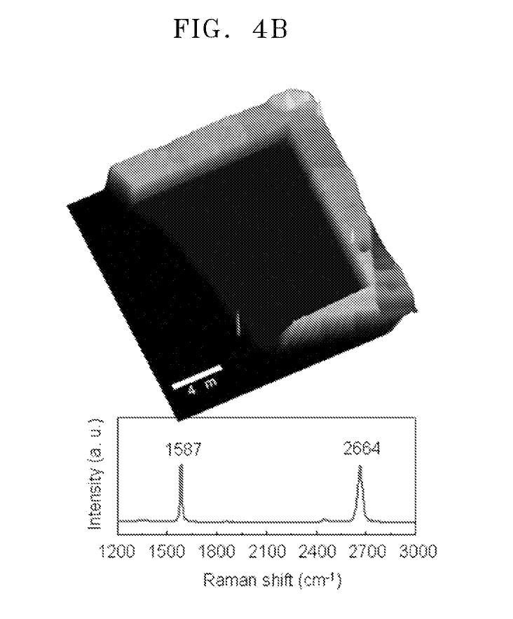

FIG. 3 shows an optical image of the resulting product after the laser light irradiation. FIG. 4A shows graphene before light is irradiated. FIG. 4B shows an atomic force microscopy (AFM) image of graphene after irradiation. In FIG. 4B, a portion of the irradiated graphene was removed and the irradiated region shows no defects. In addition, since a ratio of 2D/G in the Raman spectrum is 1 or less (FIG. 4B), it can be seen that a bilayered graphene was formed.

As described above, according to the one or more of the above embodiments, monolayer or bilayered graphene may be formed, and a non-uniform structure in a graphene, such as grains, may be removed using a simple method of irradiating a non-uniform graphene with light. Thus, uniform monolayer or bilayered graphene may be prepared. The graphene may be used in a transparent electrode, or various electric devices.

It should be understood that the exemplary embodiments described herein should be considered in a descriptive sense only and not for purposes of limitation. Descriptions of features or aspects within each embodiment should typically be considered as available for other similar features or aspects in other embodiments.

What is claimed is:

1. A method for controlling a number of graphene layers, the controlling method comprising:
forming graphene on a first surface of a first substrate, and forming a second substrate on a second surface of the first substrate; and
irradiating the graphene with light to cause constructive Fresnel interference,
wherein a multilayer structure or non-uniform structure on a surface of the graphene is removed by the constructive Fresnel interference.

2. The method of claim 1, wherein the light is a laser beam.

3. The method of claim 1, wherein a refractive index of the first substrate is smaller than a refractive index of the second substrate, and a wavelength of the light satisfies Equation 2 below:
2m×0.5λ=2nL, Equation 2
where λ is a wavelength of light, n is a refractive index of the first substrate, L is a thickness of the first substrate, and m is a positive integer.

4. The method of claim 1, wherein the number of layers of the graphene from which the multilayer or non-uniform structure is removed is one or two.

5. The method of claim 1, wherein a refractive index of the first substrate is greater than about 1 and less than about 2.5.

6. The method of claim 1, wherein the first substrate is an organic substrate, or a metal oxide substrate.

7. The method of claim 1, wherein the first substrate is at least one selected from the group consisting of SiO₂, Al₂O₃, TiO₂, ZrO₂, HfO₃, Fe₂O₃, MgO, and any combination thereof.

8. The method of claim 1, wherein the graphene formed on the first surface of the first substrate has an area of 1 cm² or more.

9. The method of claim 1, wherein the graphene formed on the first surface of the first substrate has 10 or less wrinkles per an area of 1,000 μm².

10. The method of claim 1, wherein the graphene formed on the first surface of the first substrate is present in an area of 99% or greater per 1 mm² of the graphene.

11. A monolayer or bilayer graphene prepared by the method of claim 1.

12. A transparent electrode comprising the monolayer or bilayer graphene of claim 11.

13. An electrical device comprising the monolayer or bilayer graphene of claim 11.
